(19) United States
(12) Patent Application Publication
(10) Pub. No.: US 2024/0380009 A1
(43) Pub. Date: Nov. 14, 2024

(54) POWER STORAGE CELL

(71) Applicant: TOYOTA JIDOSHA KABUSHIKI KAISHA, Toyota-shi (JP)

(72) Inventors: Takeshi ABE, Okazaki-shi (JP); Ryuta SUGIURA, Toyota-shi (JP); Tomoyuki UEZONO, Okazaki-shi (JP); Takenori IKEDA, Owariasahi-shi (JP); Yuki TAKAHASHI, Miyoshi-shi (JP); Kenta KIMURA, Toyota-shi (JP)

(73) Assignee: TOYOTA JIDOSHA KABUSHIKI KAISHA, Toyota-shi (JP)

(21) Appl. No.: 18/422,212

(22) Filed: Jan. 25, 2024

(30) Foreign Application Priority Data
May 10, 2023 (JP) 2023-077739

(51) Int. Cl. H01M 10/0587; H01M 4/02; H01M 50/533

(52) U.S. Cl. CPC H01M 10/0587; H01M 50/533; H01M 2004/021

(57) ABSTRACT

The wound electrode assembly of the power storage cell includes a strip electrode. The strip electrode includes a current collector and a composite material layer. The composite material layer includes active material particles and is disposed on the surface of the current collector. In the width direction in plan view, the strip electrode includes a first region, a second region and a third region. The first region is disposed at an end portion in the width direction. In the first region, the current collector is exposed, and the current collector is electrically connected to the electrode terminal. The second region and the third region are covered by the composite material layer. In the width direction, the second region is disposed between the first region and the third region. Reaction resistance per unit area of the second region is larger than that of the third region.

### CROSS-REFERENCE TO RELATED APPLICATION

This application claims priority to Japanese Patent Application No. 2023-077739 filed on May 10, 2023, incorporated herein by reference in its entirety.

### BACKGROUND

### 1. Technical Field

The present disclosure relates to a power storage cell.

### 2. Description of Related Art

Japanese Unexamined Patent Application Publication No. 2018-018680 (JP 2018-018680 A) discloses a strip electrode.

### SUMMARY

A power storage cell includes an electric power generating element. The electric power generating element includes, for example, a wound electrode assembly. The wound electrode assembly is formed by winding a strip electrode in a helix form. The strip electrode has a current collector portion. The current collector portion is electrically connected to an electrode terminal (external terminal). For example, the current collector portion may be disposed at an end portion of the strip electrode in a length direction thereof. When the current collector portion is disposed at the end portion in the length direction, there is a possibility that variance in electrode reaction may occur along the length direction of the strip electrode. Hereinafter, variance in the electrode reaction will also be referred to as “reaction variance”. Reaction variance may accelerate performance degradation.

In order to reduce the reaction variance in the length direction, forming a current collector portion that continuously extends over the length direction, at an end portion of the strip electrode in a width direction, is conceivable. However, in this case, there is a possibility that reaction variance will occur in the width direction.

An object of the present disclosure is to reduce reaction variance in the width direction of a strip electrode.

1. A power storage cell includes a wound electrode assembly and an electrode terminal. The wound electrode assembly includes a strip electrode. In plan view, the strip electrode manifests a length direction and a width direction. The width direction is orthogonal to the length direction. The strip electrode is wound in the length direction, such that the wound electrode assembly is fashioned. The strip electrode includes a current collector and a composite material layer. The composite material layer includes active material particles. The composite material layer is disposed on a surface of the current collector. In the width direction in plan view, the strip electrode includes a first region, a second region and a third region. The first region is disposed at an end portion in the width direction. In the first region, the current collector is exposed. In the first region, the current collector is electrically connected to the electrode terminal. The second region and the third region are covered by the composite material layer. In the width direction, the second region is disposed between the first region and the third region. Reaction resistance per unit area of the second region is larger than that of the third region.

The first region corresponds to a current collector portion. The second region is closer to the current collector portion (first region) than the third region. The second region tends to have a higher current density than the third region. It is thought that electrode reaction in the second region is accelerated more than in the third region, thereby causing reaction variance.

In the power storage cell described in the above “1”, the reaction resistance per unit area is locally different. Hereinafter, “reaction resistance per unit area” will also be referred to simply as “reaction resistance”. The second region has a greater reaction resistance than the third region. That is to say, the electrode reaction is less likely to advance in the second region than in the third region. Accordingly, reduction of reaction variance of the strip electrode in the width direction can be anticipated.

2. The power storage cell described in “1” above may include the following configuration, for example. In the second region, the composite material layer includes first active material particles. In the third region, the composite material layer includes second active material particles. A BET specific surface area of the first active material particles is smaller than that of the second active material particles.

It is thought that the smaller the BET specific surface area of the active material particles is, the smaller a reaction field (reaction area) between the active material particles and carrier ions (e.g., Li ions) will be. It is thought that the smaller the reaction area is, the greater the reaction resistance will be. That is to say, the reaction resistance of the respective regions can be adjusted by the BET specific surface area of the active material particles.

3. The power storage cell described in “1” or “2” above may include the following configuration, for example. In the second region, the composite material layer includes first composite particles. In the third region, the composite material layer includes second composite particles. Each of the first composite particles and the second composite particles includes the active material particles and a binder. The binder covers at least part of surfaces of the active material particles. A mass fraction of the first composite particles regarding the binder is larger than that of the second composite particles.

The active material particles and the binder may form composite particles, for example. The binder can inhibit ion conduction. It is thought that the reaction resistance may increase at portions where the binder adheres to the surfaces of the active material particles. The mass fraction of the binder in the composite particles is thought to correspond to an amount of adhesion of the binder and coverage of the active material particles. It is thought that the greater the mass fraction of the binder in the composite particles is, the greater the reaction resistance will be. That is to say, the reaction resistance of the respective regions can be adjusted by the mass fraction of the binder in the composite particles.

4. The power storage cell according to any one of “1” to “3” above may include the following configuration, for example. In the second region, the composite material layer includes a first layer and a second layer. In cross-sectional view of the strip electrode, the first layer is disposed between the current collector and the second layer. A mass fraction of the second layer regarding the active material particles is smaller than that of the first layer.

The mass fraction of the active material particles in a surface layer (second layer) of the composite material layer is small, and accordingly an increase in the reaction resistance can be anticipated. The mass fraction of the active material particles in the second layer may be, for example, zero. The second layer may be formed by coating a polymer solution on a surface of the first layer, for example.

5. The power storage cell according to any one of “1” to “4” above may include the following configuration, for example. The strip electrode includes an inner peripheral face and an outer peripheral face. In the wound electrode assembly, the inner peripheral face is disposed on an inner peripheral side. The outer peripheral face is an opposite face from the inner peripheral face. A first composite material layer is disposed on the inner peripheral face. A second composite material layer is disposed on the outer peripheral face. The reaction resistance per unit area of the first composite material layer is larger than that of the second composite material layer.

In the wound electrode assembly, the inner peripheral face tends to be less likely to radiate heat than the outer peripheral face. That is to say, the inner peripheral face tends to have a higher temperature than the outer peripheral face. Temperature difference between the inner peripheral face and the outer peripheral face may cause reaction variance between the inner peripheral face and the outer peripheral face. The temperature difference between the inner peripheral face and the outer peripheral face can be reduced by the composite material layer (first composite material layer) on the inner peripheral face having a larger reaction resistance than the composite material layer (second composite material layer) on the outer peripheral face. It can be anticipated that the reaction variance between the inner peripheral surface and the outer peripheral surface will be reduced by reducing the temperature difference.

An embodiment of the present disclosure (hereinafter, may be abbreviated to “present embodiment”) will be described below. Note however, that the present embodiment does not limit the technical scope of the present disclosure. The present embodiment is exemplary in all respects. The present embodiment is non-restrictive. The technical scope of the present disclosure includes all modifications within the meaning and scope equivalent to the description in the claims. For example, extracting optional configurations from the present embodiment and making optional combinations thereof is originally planned.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view illustrating an example of a power storage cell according to the present embodiment;

FIG. 2 is a schematic plan view showing an example of a strip electrode in the present embodiment;

FIG. 3 is a conceptual diagram of composite particles in the present embodiment;

FIG. 4 is a first schematic cross-sectional view showing an exemplary strip electrode according to the present embodiment; and

FIG. 5 is a second schematic cross-sectional view showing an example of a strip electrode in the present embodiment.

### DETAILED DESCRIPTION OF EMBODIMENTS

### Explanation of Terms

“reaction resistance per unit area” is measured by the following procedure. When the power storage cells in the fully discharged state are disassembled, samples having a predetermined area are cut out from the measurement target (the second region and the third region) from which the strip electrodes are collected. An evaluation cell (single cell or half cell) is created. The evaluation cell includes a sample as a working electrode. The counter electrode may be, for example, a Li foil. An AC impedance measurement is performed. Based on the measurement results, a call plot is created. In the Cole-Cole plot, two intersection points of an arc and a real axis (horizontal axis) are identified. The difference (absolute value) between the two intersections is considered the reaction resistance. By dividing the reaction resistance by the opposing area between the sample (working electrode) and the counter electrode, a value per unit area is obtained.

“Specific surface area” refers to the surface area per unit mass. “BET specific surface area” refers to the specific surface area measured by the gas adsorption method (BET1 point method). The adsorbate in the gas adsorption measurement is nitrogen.

“Plane view” indicates that the object is viewed in a line of sight parallel to the thickness direction of the object (for example, a strip electrode). The plan view 30 corresponds to a plan view. “Cross-sectional view” indicates that the object is viewed in a line of sight orthogonal to the thickness direction of the object. The cross-sectional view corresponds to a cross-sectional view.

Geometric terms (e.g., “parallel”, “orthogonal”, etc.) are not to be construed in a strict sense. For example, “parallel” may deviate somewhat from “parallel” in a strict sense. Geometric terms may include, for example, design, work, manufacturing tolerances, errors, etc. Dimensional relationships in each drawing may not match actual dimensional relationships. Dimensional relationships (length, width, thickness, etc.) in the drawings may be changed to facilitate understanding of the reader. Further, a part of the configuration may be omitted.

“Electrically connected” indicates that the two objects are conducting. The two objects may be directly connected. An electrically conductive member may connect the two objects.

The terms expressed in the singular form also indicate the aspects of the plural forms unless otherwise specified. For example, “particle” indicates not only “one particle” but also “a plurality of particles (particle group)” and “an aggregate of particles (powder)”.

For example, a numerical range such as “m % to n %” includes an upper limit value and a lower limit value unless otherwise specified. That is, “m % to n %” indicates a numerical range of “m % or more and n % or less”. In addition, “m % or more and n % or less” includes “more than m % and less than n %”.

The “power storage cell” indicates a cell that can be charged. The power storage cell is also referred to as a “secondary battery”, for example. The power storage cell may be of any battery system. The power storage cell may be, for example, a lithium ion battery or the like. The power storage cell may be a liquid-based battery, a polymer battery, or an all-solid-state battery. The power storage cell may have any profile. The power storage cell may be, for example, a cylindrical shape, a square shape, or a pouch shape. The pouch shape represents a form in which the outer casing is a pouch made of a metal foil laminate film. In the present embodiment, a cylindrical liquid-based battery is described as an example.

### Power Storage Cell

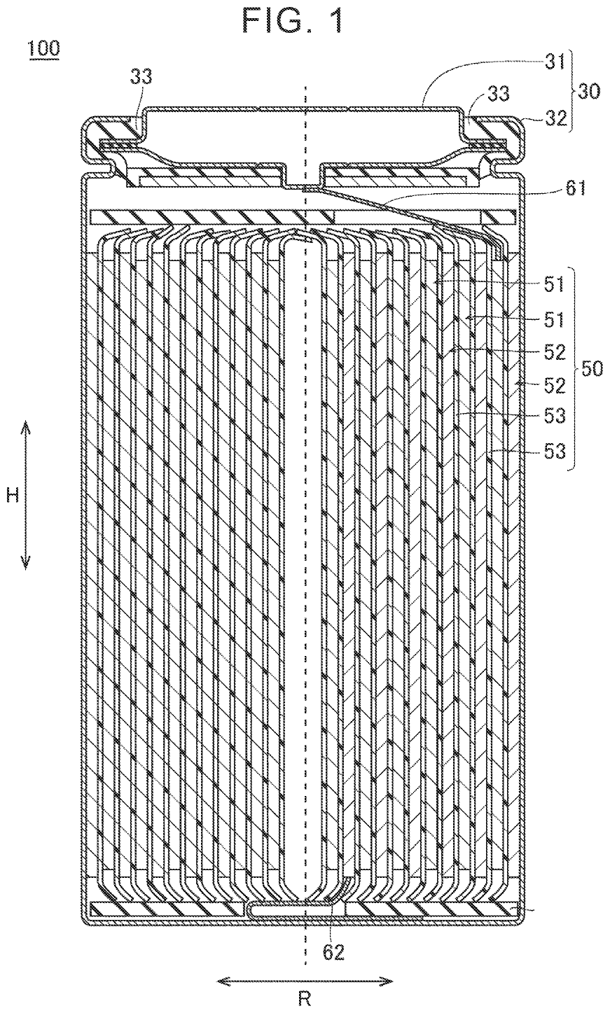

FIG. 1 is a schematic cross-sectional view illustrating an example of a power storage cell according to the present embodiment. The power storage cell 100 has a cylindrical shape. The power storage cell 100 has a height direction (H direction) and a radial direction (R direction). The power storage cell 100 includes a wound electrode assembly 50. The power storage cell 100 may further include a case 30. The case 30 houses the wound electrode assembly 50. The case 30 may be made of metal, for example. The case 30 is cylindrical. The case 30 may include, for example, a cap 31 and a can 32. The power storage cell 100 includes an electrode terminal. For example, the cap 31 and the can 32 may each function as an electrode terminal. That is, the cap 31 may have a different polarity than the can 32. If the cap 31 is positive, the can 32 is negative. If the cap 31 is negative, the can 32 is positive. For example, the gasket 33 may electrically isolate the cap 31 from the can 32.

The wound electrode assembly 50 has a cylindrical or cylindrical outer shape. Note that, for example, when the power storage cell 100 has a square shape or a pouch shape, the wound electrode assembly 50 may be formed into a flat shape by pressing the wound electrode assembly 50 in the R direction.

The wound electrode assembly 50 includes a positive electrode 51 and a negative electrode 52. The positive electrode 51 and the negative electrode 52 are both strip electrodes. That is, the wound electrode assembly 50 includes a strip electrode. The wound electrode assembly 50 may further include a separator 53. The separator 53 is interposed between the positive electrode 51 and the negative electrode 52. The separator 53 electrically separates the positive electrode 51 from the negative electrode 52. For example, the laminated body may be formed by laminating the positive electrode 51, the separator 53, and the negative electrode 52 in this order. The wound electrode assembly 50 can be formed by winding the laminated body in a spiral shape. For example, the wound electrode assembly 50 may be housed in the case 30 such that the winding axis of the wound electrode assembly 50 is parallel to the H direction.

The separator 53 may include, for example, a porous film made of resin. The electrolyte (not shown) may pass through the separator 53. The electrolyte solution may include, for example, organic solvents and a supporting electrolyte (e.g., Li salt).

The first current collector tab 61 electrically connects the positive electrode 51 and the cap 31. The second current collector tab 62 electrically connects the negative electrode 52 and the can 32. The power storage cell 100 may have, for example, a “tabless structure”. The tabless structure does not have a current collector tab. In the tabless structure, the strip electrode (at least one of the positive electrode 51 and the negative electrode 52) may be directly connected to the electrode terminal.

### Strip Electrode

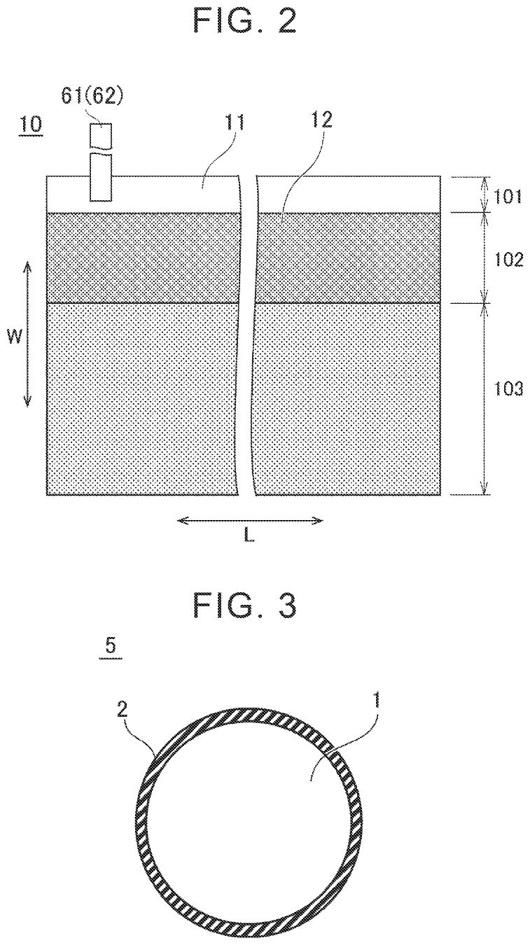

FIG. 2 is a schematic plan view illustrating an example of a strip electrode according to the present embodiment. The strip electrode 10 in FIG. 2 may be either the positive electrode 51 or the negative electrode 52. The strip electrode 10 has a length direction (L direction) and a width direction (W direction). The W direction is orthogonal to the L direction. The wound electrode assembly 50 is formed by winding the strip electrode 10 in the L direction. The W direction of the strip electrode 10 corresponds to the H direction of the power storage cell 100. In the strip electrode 10, the ratio of the dimension in the L direction to the dimension in the W direction may be, for example, any of 2 or more, 5 or more, 10 or more, or 100 or more.

The strip electrode 10 includes a current collector 11 and a composite material layer 12. The current collector 11 has electrical conductivity. The current collector 11 may be a base material of the strip electrode 10. The current collector 11 may include, for example, a metal foil. The current collector 11 may include, for example, at least one selected from the group consisting of Al, Cu, Ti, Ni and Fe.

The composite material layer 12 is disposed on the surface of the current collector 11. The composite material layer 12 may be disposed on only one side of the current collector 11, for example. The composite material layer 12 may be disposed on both surfaces of the current collector 11, for example. The composite material layer 12 may be formed by coating a composite material on the surface of the current collector.

The composite material layer 12 includes active material particles. The composite material layer 12 may further include a binder, a conductive material, and the like.

The active material particles may cause an electrode reaction (positive electrode reaction or negative electrode reaction). The active material particles may comprise any component. The active material particles may include, for example, a positive electrode active material. The positive electrode active material, for example, may include at least one selected from the group consisting of LiCoO₂, LiNiO₂, LiMnO₂, LiMn₂₀₄, Li(NiCoMn) O₂, Li(NiCoAl) O₂, and LiFcPO₄. The active material particles may include, for example, a negative electrode active material. The negative electrode active material may include, for example, at least one selected from the group consisting of graphite, soft carbon, hard carbon, Si, SiO, Si—C, Si base alloy, Sn, SnO, Sn base alloy, and Li₄Ti₅O₁₂. The term “Si—C” refers to a composite material of Si and carbon.

The binder may bond the solid material. The binder can contain any component. The binder may include, for example, at least one selected from the group consisting of polyvinylidene fluoride (PVdF), polytetrafluoroethylene (PTFE), vinylidene fluoride-hexafluoropropylene copolymer (PVdF-HFP), styrene butadiene rubber (SBR), carboxymethyl cellulose (CMC), polyimide (PI), polyamideimide (PAI), and polyacrylic acid (PAA). The blending amount of the binder may be, for example, 0.1 to 10 parts by mass with respect to 100 parts by mass of the active material particles.

The conductive material may form an electron conduction path. The conductive material may comprise any component. The conductive material may include, for example, at least one selected from the group consisting of carbon black, vapor-grown carbon fibers, carbon nanotubes, and graphene flakes. The blending amount of the conductive material may be, for example, 0.1 to 10 parts by mass with respect to 100 parts by mass of the active material particles.

### First Region, Second Region, and Third Region

In the W direction in plan view (FIG. 2), the strip electrode 10 includes a first region 101, a second region 102, and a third region 103. The first region 101 is disposed at an end portion in the W direction. The first region 101 may be disposed only at one end in the W direction. The first region 101 may be disposed at both ends in the W direction. In the first region 101, the current collector 11 is exposed. The first region 101 may be referred to as a “non-coated portion” or the like, for example. The first region 101 may be formed continuously over the entire region in the L direction. The first region 101 may be formed in a part of the L direction.

The first region 101 is a current collector portion. That is, in the first region 101, the current collector 11 is electrically connected to the electrode terminal (the cap 31 or the can 32). The first current collector tab 61 may electrically connect the current collector 11 and the cap 31 (see FIG. 1). A second current collector tab 62 may electrically connect the current collector 11 and the can 32 (see FIG. 1). Each current collector tab may be welded to the first region 101, for example. For example, in the case of the tabless structure, the end face may be formed by bending the first region 101 (the current collector 11) toward the inner peripheral side in the wound electrode assembly 50 (see FIG. 2). The end face may be orthogonal to the winding axis of the wound electrode assembly 50. The end surface may be a flat surface or a curved surface. The end surface may have irregularities. A current collector plate may be welded to the end face. The end face may be in surface contact with the current collector plate. A cap 31 or the like may be directly welded to the end face.

The second region 102 and the third region 103 are covered with the composite material layer 12. The second region 102 and the third region 103 may be referred to as a “coating portion” or the like, for example. In the W direction, the second region 102 is disposed between the first region 101 and the third region 103. The second region 102 may be adjacent to the first region 101. The second region 102 may be adjacent to the third region 103.

The second region 102 has a higher reaction resistance than the third region 103. Therefore, reduction of reaction variance in the W direction is expected. The ratio (r₂/r₃) of the reaction resistance (r₂) of the second region 102 to the reaction resistance (r₃) of the third region 103 may be, for example, any of 1.1 or more, 1.5 or more, 2 or more, 5 or more, or 10 or more. The ratio (r₂/r₃) may be, for example, any of 10 or less, 5 or less, 2 or less, or 1.5 or less.

The second region 102 and the third region 103 may be formed, for example, by applying two types of composite materials in a stripe shape. The dimensions of the second region 102 (W₂) and the dimensions of the third region 103 (W₃) in the W-direction may satisfy, for example, “W₂/W₃=5/5 to 1/9” or “W₂/W₃=3/7 to 1/9”. The dimension (W₁) of the first region 101 in the W-direction may be arbitrarily set according to, for example, a current collector configuration.

### Specific Surface Area

For example, the reaction resistance of each region may BET specific surface area of the active material particles may be adjusted. For example, in the second region 102, the composite material layer 12 may include the first active material particles. In the third region 103, the composite material layer 12 may include second active material particles. The first active material particles may have a BET specific surface area smaller than that of the second active material particles. Since BET specific surface area (S₁) of the first active material particles is smaller than BET specific surface area (S₂) of the second active material particles, the second region 102 may have a higher reaction resistance than the third region 103. The chemical composition of the first active material particles may be the same as or different from that of the second active material particles.

The ratio (S₁/S₂) of BET specific surface area (S₁) of the first active material particles to BET specific surface area (S₂) of the second active material particles may be, for example, any of 0.9 or less, 0.8 or less, 0.7 or less, 0.6 or less, 0.5 or less, 0.4 or less, 0.3 or less, 0.2 or less, or 0.1 or less. The ratio (S₁/S₂) may be, for example, any of 0.1 or more, 0.2 or more, 0.3 or more, 0.4 or more, 0.5 or more, 0.6 or more, 0.7 or more, or 0.8 or more. BET specific surface area (S₁) and BET specific surface area (S₂) may each independently be, for example, 0.1 to 10 m²/g.

### Composite Particle

FIG. 3 is a conceptual diagram of composite particles in the present embodiment. For example, the composite particles 5 include active material particles 1 and a binder 2. The binder 2 covers at least a part of the surface of the active material particles 1. The composite particles 5 may further include a conductive material (not shown). For example, the binder 2 may fix the conductive material to the active material particles 1. The composite particles 5 may be formed by any particle compounding process. For example, the composite particles 5 may be formed by mixing the active material particles 1 and the binder 2 under conditions in which a strong shear force is applied. For example, the particle compounding treatment may be performed by a product name “Mechano Hybrid” manufactured by Nippon Coke Industry Co., Ltd., or the like.

For example, the reaction resistance of each region may be adjusted by the mass fraction of the binder in the composite particles. For example, in the second region 102, the composite material layer 12 may include the first composite particles. In the third region 103, the composite material layer 12 may include second composite particles. The first composite particles may have a greater mass fraction of binder than the second composite particles. The mass fraction of the binder in the first composite particles (B₁) may be larger than the mass fraction of the binder in the second composite particles (B₂), so that the second region 102 may have a higher reaction resistance than the third region 103. The chemical composition of the active material particles and the binder in the first composite particles may be the same as or different from that of the second composite particles.

The ratio of the mass fraction of the binder in the first composite particles (B₁) to the mass fraction of the binder in the second composite particles (B₂) (B₁/B₂) may be, for example, any of 1.1 or more, 1.5 or more, 2 or more, 5 or more, or 10 or more. The ratio (B₁/B₂) may be, for example, any of 10 or less, 5 or less, 2 or less, or 1.5 or less. The mass fraction of the binder (B₁) and the mass fraction of the binder (B₂) may each independently be 0.1 to 10%.

### Multilayer Structure

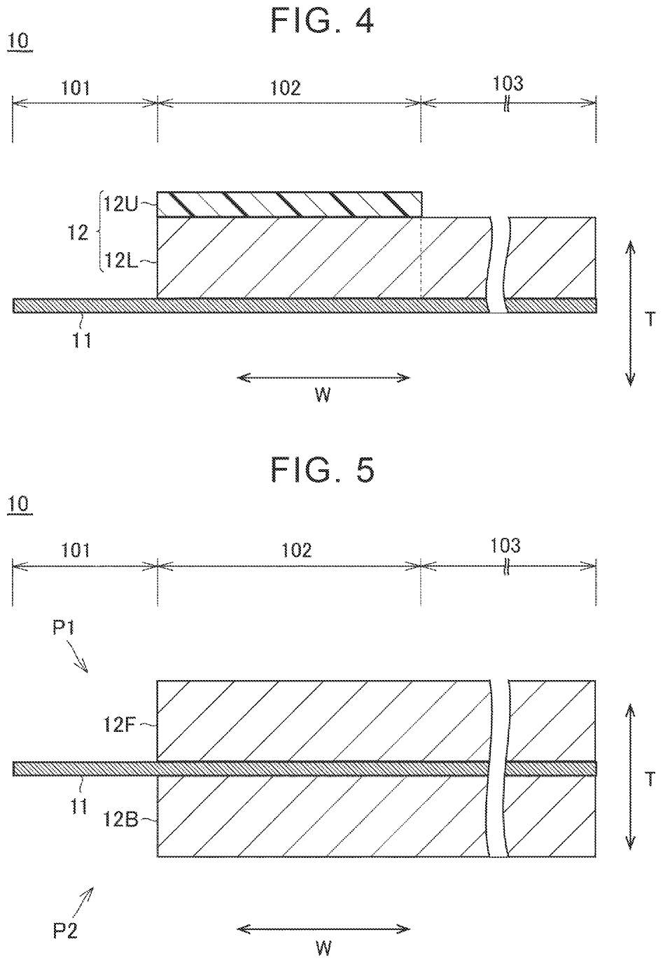

FIG. 4 is a first schematic cross-sectional view showing an example of a strip electrode according to the present embodiment. The thickness direction (T direction) of the strip electrode 10 corresponds to the R direction of the power storage cell 100. For example, in the second region 102, the reaction resistance of each region may be adjusted by the composite material layer 12 having a multilayer structure. For example, in the second region 102, the composite material layer 12 may include the first layer 12L and the second layer 12U. The first layer 12L and the second layer 12U may be referred to as, for example, a lower layer, an upper layer, and the like. In a cross-sectional view (FIG. 4), the first layer 12L is disposed between the current collector 11 and the second layer 12U. The second layer 12U may have a smaller mass fraction of the active material particles than the first layer 12L. The ratio (A₂/A₁) of the mass fraction of the active material particles in the second layer 12U (A₂) to the mass fraction of the active material particles in the first layer 12L (A₁) may be, for example, any of 0.9 or less, 0.8 or less, 0.7 or less, 0.6 or less, 0.5 or less, 0.4 or less, 0.3 or less, 0.2 or less, or 0.1 or less. The ratio (A₂/A₁) may be, for example, any of 0.1 or more, 0.2 or more, 0.3 or more, 0.4 or more, 0.5 or more, 0.6 or more, 0.7 or more, or 0.8 or more. The mass fraction (A₂) of the active material particle in the second layer 12U may be, for example, zero.

The second layer 12U may include, for example, inorganic fillers, solid-state electrolytes, gel-electrolytes, polymers, and the like. The second layer 12U may include, for example, at least one selected from the group consisting of alumina, bochmite, titania, polyethylene (PE), PI, aramid, PVdF, PVdF-HFP, PAA, CMC, polyvinyl alcohol (PVA), and polyethylene oxide (PEO). When the second layer 12U does not contain active material particles, the second layer 12U may extend to cover a part of the top surface of the current collector 11, for example, in the W-direction. The first layer 12L may have, for example, the same composition as the composite material layer 12 in the third region 103. For example, a polymer solution (for example, a PVdF-HFP solution or the like) may be applied to the second region 102 (the composite material layer 12) to form the second layer 12U.

### Gradient (Composition Gradient)

The composition of the composite material layer 12 may be changed in the second region 102. For example, the composition of the composite material layer 12 may be continuously or stepwise changed in the W direction. For example, the composition of the composite material layer 12 may be changed so that the reaction resistance becomes larger as the first region 101 (current collector portion) is approached. For example, the mass fraction of the active material particles may decrease as the area approaches the first region 101. For example, the closer to the first region 101, the greater the mass fraction of the binder may be.

### Inner and Outer Peripheral Surfaces

FIG. 5 is a second schematic cross-sectional view showing an example of a strip electrode in the present embodiment. The strip electrode 10 has an inner peripheral surface P1 and an outer peripheral surface P2. In the wound electrode assembly 50, the inner peripheral surface P1 is disposed on the inner circumferential side. The outer peripheral surface P2 is opposite to the inner peripheral surface P1. The first composite material layer 12F is disposed on the inner peripheral surface P1. The second composite material layer 12B is disposed on the outer peripheral surface P2. For example, the first composite material layer 12F may have a higher reaction resistance than the second composite material layer 12B. For example, the second region 102 in the first composite material layer 12F may have a higher reaction resistance than the second region 102 in the second composite material layer 12B. For example, the third region 103 in the first composite material layer 12F may have a higher reaction resistance than the third region 103 in the second composite material layer 12B.

The ratio of the reaction resistance (r_{F}) of the first composite material layer 12F to the reaction resistance (r_{B}) of the second composite material layer 12B (r_{F}/r_{B}) may be, for example, any of 1.1 or more, 1.5 or more, 2 or more, 5 or more, or 10 or more. The ratio (r_{F}/r_{B}) may be, for example, any of 10 or less, 5 or less, 2 or less, or 1.5 or less.

What is claimed is:

1. A power storage cell comprising:
a wound electrode assembly; and
an electrode terminal, wherein
the wound electrode assembly includes a strip electrode,
in plan view, the strip electrode manifests a length direction and a width direction,
the width direction is orthogonal to the length direction,
the strip electrode is wound in the length direction, such that the wound electrode assembly is fashioned,
the strip electrode includes a current collector and a composite material layer,
the composite material layer includes active material particles,
the composite material layer is disposed on a surface of the current collector,
in the width direction in the plan view, the strip electrode includes a first region, a second region and a third region,
the first region is disposed at an end portion in the width direction,
in the first region, the current collector is exposed,
in the first region, the current collector is electrically connected to the electrode terminal,
the second region and the third region are covered by the composite material layer,
in the width direction, the second region is disposed between the first region and the third region, and
reaction resistance per unit area of the second region is larger than that of the third region.

2. The power storage cell according to claim 1, wherein:
in the second region, the composite material layer includes first active material particles;
in the third region, the composite material layer includes second active material particles; and
a BET specific surface area of the first active material particles is smaller than that of the second active material particles.

3. The power storage cell according to claim 1, wherein:
in the second region, the composite material layer includes first composite particles;
in the third region, the composite material layer includes second composite particles;
each of the first composite particles and the second composite particles includes the active material particles and a binder;
the binder covers at least part of surfaces of the active material particles; and
a mass fraction of the first composite particles regarding the binder is larger than that of the second composite particles.

4. The power storage cell according to claim 1, wherein:
in the second region, the composite material layer includes a first layer and a second layer;
in cross-sectional view of the strip electrode, the first layer is disposed between the current collector and the second layer; and
a mass fraction of the second layer regarding the active material particles is smaller than that of the first layer.

5. The power storage cell according to claim 1, wherein:
the strip electrode includes an inner peripheral face and an outer peripheral face;
in the wound electrode assembly, the inner peripheral face is disposed on an inner peripheral side;
the outer peripheral face is an opposite face from the inner peripheral face;
a first composite material layer is disposed on the inner peripheral face;
a second composite material layer is disposed on the outer peripheral face; and
the reaction resistance per unit area of the first composite material layer is larger than that of the second composite material layer.
